(19) United States
(12) Patent Application Publication
(10) Pub. No.: US 2010/0128945 A1
(43) Pub. Date: May 27, 2010

(54) SYNCHRONIZATION OF X-RAY SOURCE POSITION DURING CARDIAC-GATED COMPUTED TOMOGRAPHY

(75) Inventors: Erik L. Ritman, Rochester, MN (US); Steven M. Jorgensen, Rochester, MN (US); Cynthia H. McCollough, Byron, MN (US); Andrew N. Primak, Rochester, MN (US)

Correspondence Address: FAEGRE & BENSON LLP;PATENT DOCKETING - INTELLECTUAL PROPERTY 23/24, 2200 WELLS FARGO CENTER, 90 SOUTH SEVENTH STREET, MINNEAPOLIS, MN, 55402-3901, US

(73) Assignee: MAYO FOUNDATION FOR MEDICAL EDUCATION AND RESEARCH, Rochester, MN (US)

(21) Appl. No.: 12/528,506

(22) PCT Filed: Feb. 26, 2008
(86) PCT No.: PCT/US08/54962

§ 371 Date: Feb. 1, 2010

Related U.S. Application Data
(60) Provisional application No. 60/903,384, filed on Feb. 26, 2007.

(51) Int. Cl. G06K 9/00; H05G 1/60

(52) U.S. Cl. 382/130; 382/131; 378/8

(57) ABSTRACT

A method for temporally imaging a cyclic body structure during a predetermined phase of its cycle using a CT scanner of the type having a rotating radiation source. In one embodiment the image or other display is generated using data produced when the radiation source is at a predetermined position when the body structure is in the predetermined phase. The method can be performed by using only data collected when the radiation source is at the predetermined position and the body structure is in the predetermined phase, by stimulating the body structure so the phase of the body structure and location of the radiation source are synchronized, or by controlling the motion of the radiation source so the location of the radiation source and the phase of the body structure are synchronized.

### REFERENCE TO RELATED APPLICATION

This application claims the benefit of U.S. Provisional Application Ser. No. 60/903,384, filed on Feb. 26, 2007, and entitled Synchronization Of X-Ray Source Position During Cardiac-Gated Computed Tomography, which is incorporated herein by reference in its entirety.

### FIELD OF THE INVENTION

The invention is a system and method for performing computed tomography (CT).

### BACKGROUND OF THE INVENTION

Computed tomography (CT) imaging systems are well known and in widespread use. Cardiac or ECG-gated techniques for using CT systems to image a patient's heart over time at specific phases are also known and in widespread use. For example, ECG-gated CT scanning is commonly used to image a patient's heart using data acquired in sequential cardiac cycles. Data generated by this scanning technique is used to produce anatomic images of the heart. CT systems and ECG-gating techniques of these types are disclosed, for example, in the following U.S. Patents, all of which are incorporated herein by reference.

| Inventor Name | Patent No. |
|---|---|
| Dafni et al. | 5,966,422 |
| Blake et al. | 6,275,560 |
| Hu et al. | 6,370,217 |

Commercially available CT systems have x-ray tubes that rotate about the subject. The best temporal resolution is achieved in these systems using less than a full 360° of x-ray tube rotation to reconstruct an image. This approach is known as partial or half-scan reconstruction. Scanners that rotate sufficiently rapidly to generate the half scan data may not need to use ECG gating scan data methods..

FIGS. 1A-1D illustrate known ECG-gated CT scanning approaches using scanners of this type. This example is representative of a scan at which HR=90 BPM and the rotation speed (2π) is 0.5 seconds. FIG. 1A is the ECG of a patient's heart. The shaded region is the diastolic phase of the heart cycle—the phase during which it is typically desired to measure the heart wall's transient opacification. FIG. 1B is the corresponding volume of the left ventricle of the patient's heart. During the slow filling phase of disastole the heart has the least change in chamber volume and is least sensitive to motion artifact. FIG. 1C illustrates a square wave signal gated to the diastolic phase of the heart cycle and indicating when recording of the CT scan data should occur. FIG. 1D is a sequence of schematic representations of the patient's chest in cross section and the location of a single x-ray source as it rotates around the patient, illustrating the views of the radiation source. Data collected from sequential views (each of which provides less than the required range of angles of view) are used to build up a 360° scan data set to make the multislice images.

Unfortunately, the lack of 360° symmetry in these known imaging approaches introduces errors that degrade the accuracy of the measured CT data values (e.g., variations in the grey scale of the heart muscle). These errors can manifest themselves as relatively high-frequency variations in contrast agent dilution curves, and can make quantitative analysis more difficult and less reproducible. There is, therefore, a continuing need for improved CT scanning systems and methods.

### BRIEF DESCRIPTION OF THE DRAWINGS

FIG. 1A is a prior art illustration of a patient's ECG.

FIG. 1B is a prior art illustration of the left ventricle chamber volume corresponding to the ECG shown in FIG. 1A.

FIG. 1C is an illustration of a signal gated to the diastolic phase of the heart cycle shown in FIGS. 1A and 1B, showing prior art CT scan data recording.

FIG. 1D is a sequence of schematic representations of the relative locations of the x-ray source and patient's chest during the prior art CT scanning approach shown in FIGS. 1A-1C.

FIG. 2A is an illustration of a patient's ECG.

FIG. 2B is a sequence of schematic representations of the relative locations of the x-ray sources and patient's chest during CT scanning in accordance with one embodiment of the invention.

FIG. 2C is a sequence of schematic representations of the relative locations of the x-ray sources and patient's chest during a prior art CT scanning approach.

FIG. 3A is a schematic illustration of a patient within a CT scanner having two radiation sources.

FIG. 3B is an illustration of the ECG of the patient shown in FIG. 3A.

FIG. 3C is an illustration of a signal that can be used to control a detection window for CT scanning in accordance with one embodiment of the invention.

FIG. 3D is an illustration of the “once around” signal detected by a CT scanner in accordance with one embodiment of the invention.

FIGS. 3E and 3F are illustrations of signals that can be used to control a detection window for CT scanning in accordance with other embodiments of the invention.

FIG. 3G is a table describing the relative timing of detection windows for different heart rates in accordance with embodiments of the invention.

FIG. 4A is an illustration of a contrast agent dilution curve from data measured using a prior art CT scanning approach.

FIG. 4B is the image corresponding to the dilution curve shown in FIG. 4A.

FIG. 5A is an illustration of a contrast agent dilution curve from data measured using a CT scanning approach in accordance with one embodiment of the invention.

FIG. 5B is the image corresponding to the dilution curve shown in FIG. 5A.

FIG. 6 is a graphical illustration of the corresponding once-around scanner receiver positions and associated detection windows before and after contrast agent injection for scanning in accordance with another embodiment of the invention.

FIG. 7 is a graph of the time sequence of changing myocardial CT numbers in a sequence of heart cycles before and after processing in accordance with the embodiment of the invention described in connection with FIG. 6.

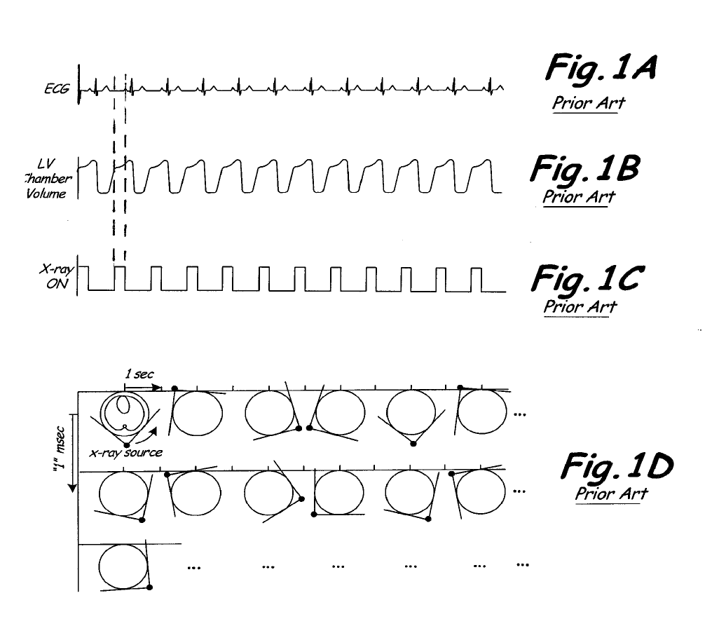

### SUMMARY

The invention is a method for temporally imaging a cyclic body structure during a predetermined phase of its cycle using a scanner of the type having a rotating radiation source. In one embodiment the image or other display is generated using data produced when the radiation source is at a predetermined position when the body structure is in the predetermined phase. The method can be performed by using only data collected when the radiation source is at the predetermined position and the body structure is in the predetermined phase, by stimulating the body structure so the phase of the body structure and location of the radiation source are synchronized, or by controlling the motion of the radiation source so the location of the radiation source and the phase of the body structure are synchronized.

### DETAILED DESCRIPTION OF THE INVENTION

The invention is a method for temporally imaging a cyclic body structure during a predetermined phase of its cycle using a CT scanner of the type having one or more radiation sources such as x-ray tubes. The image is generated using data produced when the radiation source is at a predetermined position when the body structure is in the predetermined phase. The method can, for example, be used to generate contrast agent dilution curves during the diastolic phase of a patient's cardiac cycle. Other approaches for synchronizing the location of the radiation source to the phase of the body structure during its cyclic activity can also be used.

In one embodiment, the method is performed using only data collected when the radiation source is at the predetermined position and the body structure is in the predetermined phase. In another embodiment, the method is performed by stimulating the body structure (e.g., pacing the heart) so the phase of the body structure and the location of the radiation source are synchronized. In yet another embodiment, the motion of the radiation source is controlled as a function of the phase of the body structure (e.g., using a phase-locked loop) so the location of the radiation source and the phase of the body structure are synchronized. Additionally, algorithms that retrospectively interpolate the acquired data to achieve the desired synchronization are another embodiment of this invention.

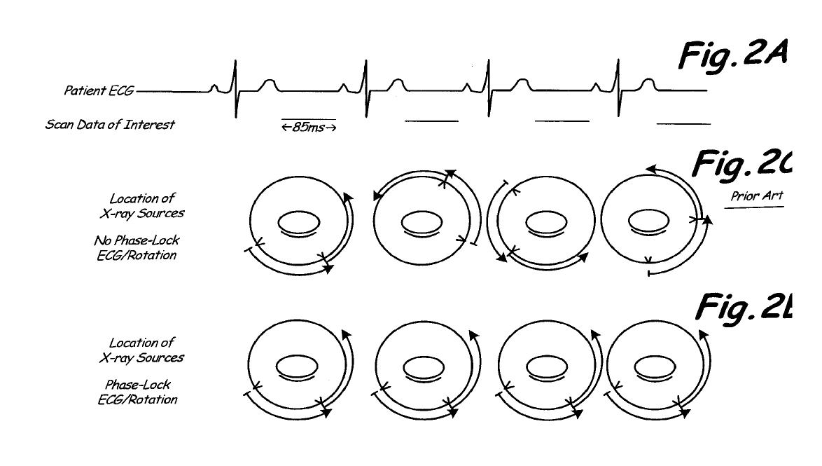

FIGS. 2A and 2B illustrate the invention. FIG. 2A is an ECG illustrating the 83 msec. phase during diastole that is desired to be imaged in sequential heart cycles to produce data for a contrast dilution curve. FIG. 2B shows that the ECG phase and angular positions or locations of the two rotating CT scanner radiation sources (spaced 90° apart) relative to the patient's anatomy are synchronized during subsequent cardiac cycles. This scanning and imaging methodology can reduce the beat-to-beat variation of generated CT grey-scale values. FIG. 2C, in contrast, shows the same system operated in accordance with conventional ECG gating. As shown, the locations of the radiation sources relative to the patient's anatomy vary from heartbeat to heartbeat. As noted above, this variation can cause artifact in the generated data and associated visual displays (e.g., images and graphs).

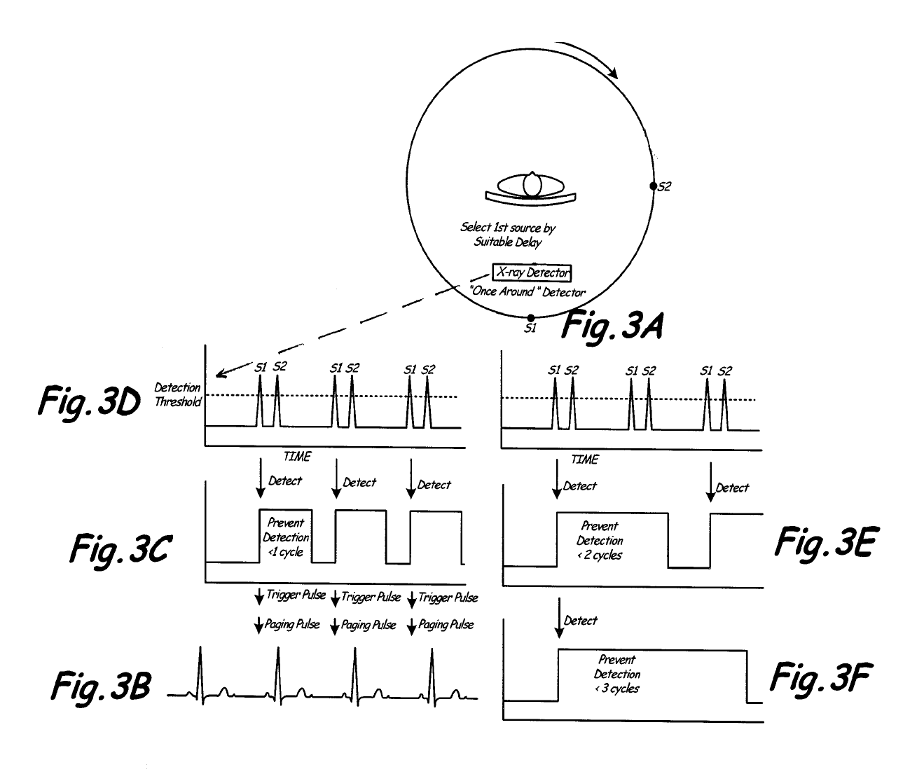

FIGS. 3A-3G illustrate additional features of the schema for phase-locked cardiac pacing and CT rotation cycle of the invention. FIG. 3A is a schematic illustration of a patient within a scanner having two x-ray sources S1 and S2. FIG. 3B is a graphic representation of the patient's ECG. FIG. 3D is an illustration of the “once around” signal derived from an x-ray sensor (not shown) positioned close to the plane scanned by the sources as they rotate around the patient. The double reflection (denoted S1 and S2 in FIG. 3D) is due to the two radiation sources passing the detector in rapid succession. By detecting the upswing or signal rise, a delay signal illustrated in FIG. 3C can be activated and used to prevent double triggering on the second radiation source. The delay can be prolonged or extended so that only every second or third scanner gantry rotation is scanned or detected (e.g., as illustrated in FIGS. 3E and 3F). Different heart rates such as those listed in the table of FIG. 3G can then be accommodated. By controlling the gantry rotation rate, heart rates different than those listed in FIG. 3G for the 330 msec. rotation speed can be accommodated.

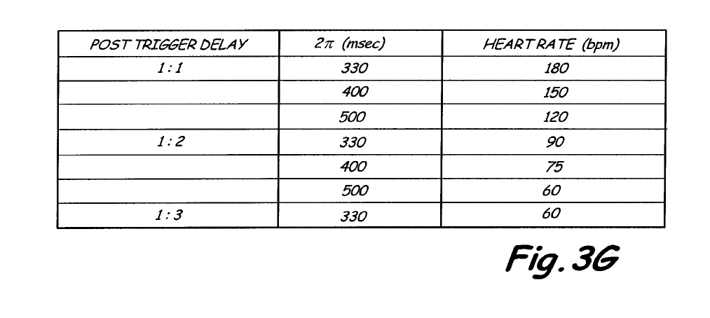

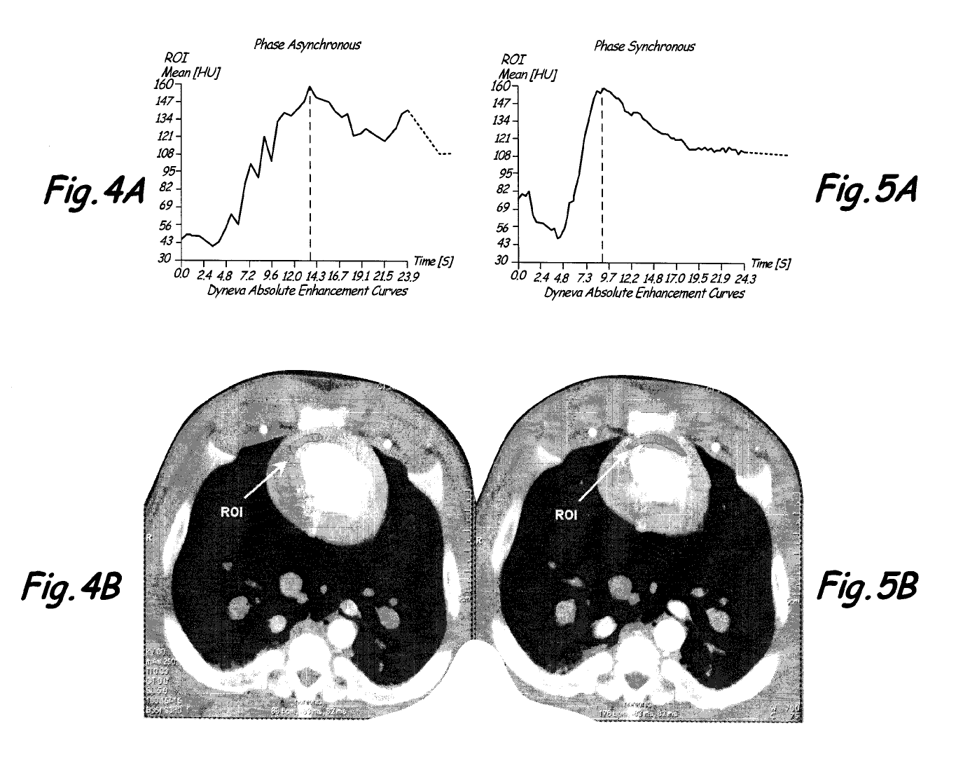

The advantages of the invention are illustrated in connection with FIGS. 4A, 4B, 5A and 5B. FIG. 4A is a graphical image or display of a contrast agent dilution curve measured during CT scanning using a conventional dual source CT scanner and ECG gating. Large and rapid variations in the curve are evident. FIG. 4B is a corresponding image of the heart. FIG. 5A is a graphical image or display of a contrast agent dilution curve measured using the synchronized approach of the invention. It is evident that the curve is much smoother. The initial variation prior to the start of the curve upswing is due to the lack of synchronization because of manual initiation of the synchronization.

The invention avoids degradation in accuracy and allows consistent measurement of the CT numbers in partial scan reconstructions. Using only data from reproducible angular positions, the time-varying artifact's effect is avoided, and consistent CT numbers can be obtained. The patient's heart is paced directly in one embodiment of the invention. By skipping sequential rotations, slower heart rates can be accommodated. By adjusting the radiation source rotation cycle duration, additional different heart rates can be achieved. In embodiments with non-paced patients, a software algorithm can be implemented to achieve similar results by adjusting the scanner rotation cycle duration to the heart cycle duration. The advantages offered by the invention are substantial since partial scan reconstructions are commonly used to optimize temporal resolution, yet many applications (e.g., tissue perfusion, vascular stenosis and plaque assessment) require quantitative accuracy.

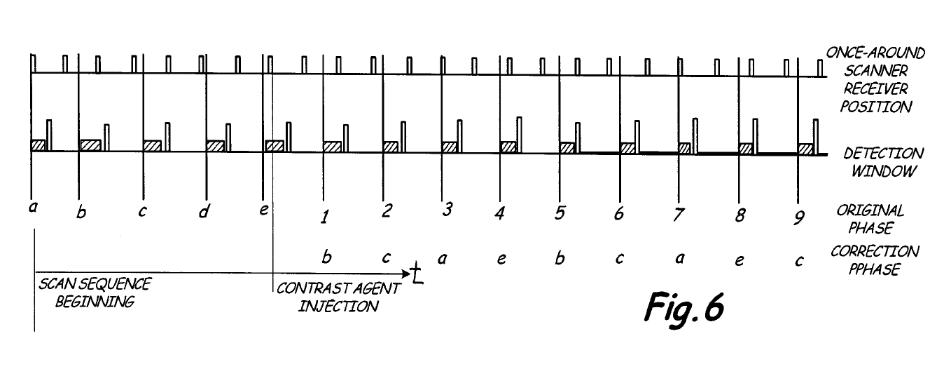

Another embodiment of the invention can be described with reference to FIG. 6. In this embodiment of the invention the patient is scanned with a spontaneous heart rate, and the positions of the radiation source need not be physically synchronized to the phase of the cyclic activity of the body structure in the images that are used. Instead, the radiation source location is effectively electronically synchronized to the phase of the body structure. This is done by subtracting from the CT images of interest (e.g., the post-dye injection images) background images (e.g., the pre-dye injection images) having the same radiation source location phase as those of the CT images of interest.

To apply the synchronization method to subjects scanned with spontaneous heart rate, a number of heart cycles are scanned prior to the injection of intravascular contrast agent. A scan can include all phases of the cardiac cycle, or a prospectively ECG-gated phase of the cardiac cycle (e.g., end-diastole). The number of heart cycles depends on the actual heart cycle duration (approximately 0.3-1.3 seconds) relative to the rotation time of the CT scanner (typically 0.3-0.5 seconds). If the heart cycle duration is an exact multiple of the CT scanner rotation time (e.g., a 330 msec. rotation time with a heart cycle duration of 330, 660, 990 or 1320 msec.), then only one cardiac cycle before the dye injection need be scanned.

If the heart cycle duration is T and CTᵣₒₜ is the scanner rotation time, then there will be N mismatched rotation cycles between the next coinciding phase of the heart and rotation cycle, where N=n(T/(T−CTᵣₒₜ)) and n is an integer. Therefore, for CTᵣₒₜ=330msec. and T=500 msec. (i.e., 120 beats per minute), the lowest integer N value is nine heart cycles. An example of this type is shown in FIG. 6, where a sequence of five pre-contrast injection images a-e are taken. Also shown in FIG. 6 are the pre-contrast injection images having the same radiation source location phases as the post-contrast injection images. In accordance with the invention all or some of the post-contrast injection images can be used after the corresponding pre-contrast injection image with the same radiation source location phase is subtracted from the post-contrast injection image.

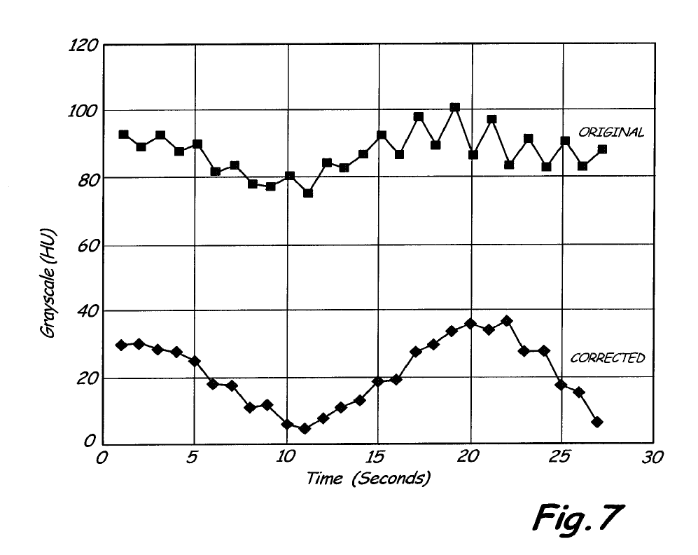

FIG. 7 is a graph illustrating the results of the electronic synchronization method, showing the time sequence of changing myocardial CT numbers in a sequence of heart cycles. In the upper graph of FIG. 7 is an original curve which oscillates rapidly from scan to scan with a variable amplitude depending on the angular location of the x-ray source trajectory during the scan. The lower graph in FIG. 7 shows the same CT data as the upper graph, but after subtraction of the same radiation source location phase pre-contrast injection image data (during which the myocardium increases in brightness due to passage of intravascular contrast medium through the myocardium). The CT data represented by the lower graph results in a smooth curve without the rapid oscillations in CT image gray-scale, but leaves the change in gray-scale due to that contrast agent.

Although the invention has been described with reference to preferred embodiments, those skilled in the art will recognize that changes can be made in form and detail without departing from the spirit and scope of the invention.

1. A method for temporally imaging a cyclic body structure during a predetermined phase of its cycle using a scanner of the type having a rotating radiation source, including generating the image or other display using data produced when the radiation source is at a predetermined position when the body structure is in the predetermined phase.

2. Performing the method of claim 1 by using only data collected when the radiation source is at the predetermined position and the body structure is in the predetermined phase.

3. Performing the method of claim 1 by stimulating the body structure so the phase of the body structure and the location of the radiation source are synchronized.

4. Performing the method of claim 1 by controlling the motion of the radiation source so the location of the radiation source and the phase of the body structure are synchronized.

5. Performing the method of claim 1 by interpolating acquired data such that the location of the radiation source and the phase of the body structure are synchronized in the interpolated data.

6. Performing the method of any of claim 1 using a CT scanner having one or more radiation sources.

7. Images produced by the method of claim 1.

8. A scanner controlled to perform the method of claim 1.

9. A method for performing cardiac gated CT scanning using a CT scanner having one or more radiation sources, including synchronizing the location of a radiation source to the phase of the cardiac cycle.

10. The method of claim 9, including controlling the CT scanner to synchronize the location of a radiation source to the phase of the cardiac cycle.

11. A CT scanner controlled to perform the method of claim 10.

12. The method of claim 9, including controlling the cardiac cycle to synchronize the location of a radiation source to the phase of the cardiac cycle.

13. A method for imaging a cyclic body structure during a predetermined phase of its cycle produced by a scanner having a rotating radiation source, including:
obtaining a plurality of pre-contrast injection images of the body structure during the predetermined phase at a plurality of radiation source location phases;
obtaining a plurality of post-contrast injection images of the body structure during the predetermined phase at a plurality of radiation source location phases; and
subtracting from the post-contrast injection images the pre-contrast injection images having the corresponding radiation source location phases.

14. The method of claim 13 and further including displaying the post- contrast injection images after subtraction of the corresponding pre-contrast injection images.

15. A method for processing images of a cyclic body structure taken during a predetermined phase of its cycle, including subtracting from post-contrast injection images at radiation source location phases pre-contrast injection images having corresponding radiation source location phases.

16. The method of claim 15 and further including displaying the post-contrast injection images after subtraction of the corresponding pre-contrast injection images.
